(19) United States
(12) Patent Application Publication
(10) Pub. No.: US 2016/0105323 A1
(43) Pub. Date: Apr. 14, 2016

(54) NODE IDENTIFICATION USING CLUSTERS

(71) Applicant: Microsoft Corporation, Redmond, WA (US)

(72) Inventors: Bernhard Haeupler, Pittsburgh, PA (US); Dahlia Malkhi, Palo Alto, CA (US)

(21) Appl. No.: 14/513,467

(22) Filed: Oct. 14, 2014

(51) Int. Cl. H04L 12/24; H04L 12/911

(52) U.S. Cl. CPC H04L 41/12; H04L 47/70; H04L 41/0806

(57) ABSTRACT

During an initialization phase, some nodes of a network form clusters. The nodes in a cluster share information with a leader node, which knows all of the nodes that each of the nodes in the cluster is aware of. During a growth phase, clusters are randomly activated or deactivated. The nodes of the activated clusters message randomly selected known nodes, asking the nodes to merge with the cluster. The nodes of deactivated clusters determine which activated cluster to join based on received messages. After the growth phase ends, the remaining clusters may merge to form a single cluster, and the list of nodes known to the leader of the single cluster may be shared as the list of all nodes on the network.

### BACKGROUND

A distributed network may include a variety of network resources such as a multitude of clients, servers, printers, etc. Each of these network resources may be represented by a node in the distributed network. Because distributed networks often lack a central authority, and nodes may frequently enter and leave the network, identifying all of the network resources that are available on the network at a given time may be difficult. Determining the nodes that are available on a network at a particular time is known as resource discovery. Similarly, identifying at each node all nodes closely connected to it (e.g., neighbors of neighboring nodes) may also be difficult. Each node learning about all node identities known by its neighboring nodes is known as local flooding.

### SUMMARY

During a local flooding or resource discovery algorithm, the nodes of a network are partitioned into clusters. Initially, each node may form its own cluster. The nodes in a cluster share information with a leader node, which knows all of the nodes that each of the nodes in the cluster is aware of. During one or more growth phases, clusters are randomly activated or deactivated. The nodes of the activated clusters message randomly selected nodes known to their cluster asking the entire clusters of the contacted nodes to merge with the cluster that initiated the contact. The deactivated clusters determine which activated cluster to join based on received messages. If after a growth phase ends all clusters have merged to a single cluster the resource discovery problem is solved as the list of nodes known to the leader of the single cluster may then be shared as the list of all nodes on the network.

In an implementation, it is determined by a computing device that a number of nodes in a first cluster of a plurality of clusters is greater than a first threshold. Each cluster comprises one or more nodes, each node is assigned to one cluster, each node comprises a node identifier that identifies the node, each node comprises a cluster identifier that identifies the cluster that the node is assigned to, and each node comprises a list of the nodes that the node is aware of. In response to determining that the number of nodes in the first cluster is greater than the first threshold, the first cluster is activated or deactivated by the computing device. While the first cluster is activated: each node in the first cluster is instructed to select a first node from the list of nodes that the node is aware of by the computing device; and each node in the first cluster is instructed to send a message to the selected first node by the computing device. A request to identify the nodes of the plurality of nodes is received at the computing device. In response to the request, the list of nodes associated with a node of the first cluster is provided by the computing device.

In an implementation, a first cluster is activated or deactivated by a computing device. Each cluster comprises one or more nodes, each node is assigned to one cluster, each node comprises a node identifier that identifies the node, each node comprises a cluster identifier that identifies the cluster that the node is assigned to, and each node comprises a list of the nodes that the node is aware of. While the first cluster is activated: each node in the first cluster is instructed to select a first node from the list of nodes that the node is aware of by the computing device; and each node in the first cluster is instructed to send a message to the selected first node by the computing device. The message includes the cluster identifier associated with the first cluster. While the first cluster is deactivated: cluster identifiers are received from one or more of the nodes in the first cluster by the computing device; a cluster identifier is selected from the received cluster identifiers by the computing device; and each node in the first cluster is instructed to join the cluster identified by the selected cluster identifier by the computing device.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there is shown in the drawings example constructions of the embodiments; however, the embodiments are not limited to the specific methods and instrumentalities disclosed. In the drawings:

FIG. 1 is an illustration of an exemplary environment for discovering nodes in a distributed network;

FIG. 2 is an illustration of two exemplary clusters;

FIG. 3 is an illustration of an exemplary discovery engine;

FIG. 4 is an illustration of an operational flow of a method for performing an initialization phase;

FIG. 5 is an illustration of an operational flow of a method for performing a growth phase;

FIG. 6 is an illustration of an operational flow of a method for determining node identifiers in response to a request; and

FIG. 7 shows an exemplary computing environment in which example embodiments and aspects may be implemented.

### DETAILED DESCRIPTION

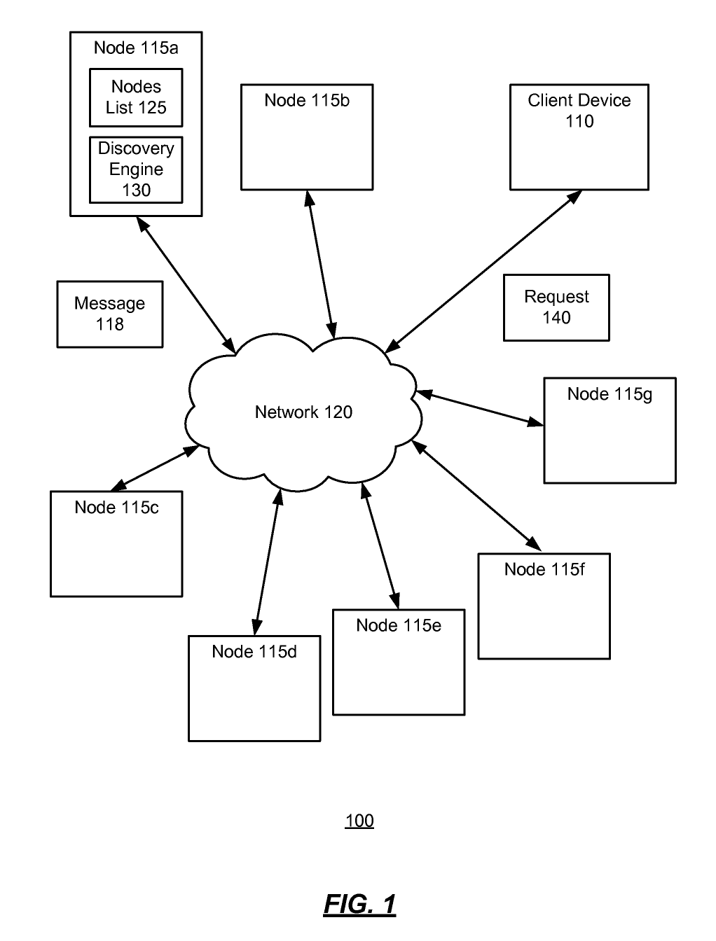

FIG. 1 is an illustration of an exemplary environment 100 for discovering nodes 115 in a distributed network 120. The environment 100 may include a plurality of nodes 115 (i.e., nodes 115a-g) and a client device 110 in communication through the network 120. The network 120 may be a variety of network types including the public switched telephone network (PSTN), a cellular telephone network, and a packet switched network (e.g., the Internet). Although only one client device 110, and seven nodes 115 are shown in FIG. 1, there is no limit to the number of client devices 110 and nodes 115 that may be supported.

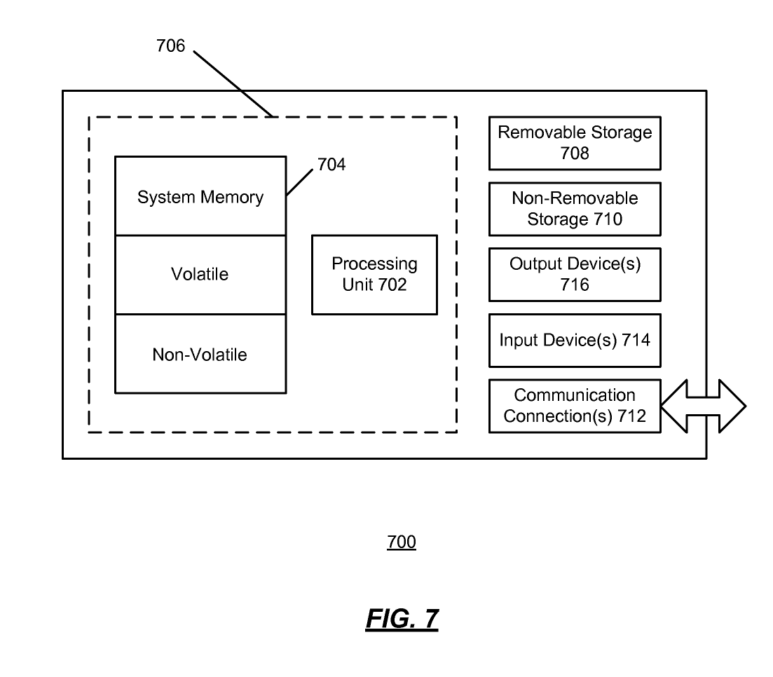

The nodes 115 may represent network resources that are available to the client device 110 on the network 120. The network resources may include, but are not limited to, hardware devices such as printers, scanners, storage devices, and computing devices such as the computing device 700 illustrated with respect to FIG. 7. The network resources may also include software applications and services, as well as virtual devices, for example.

Each node 115 may include a node identifier. Depending on the implementation, the node identifier may be an address on the node 115 on the network 120 such as an IP address. Other types of identifiers may be used. Each node identifier may be associated with one node 115, and may be used by the client device 110, or another node 115, to connect with a node 115.

The client device 110 may make use of one or more services provided by the nodes 115. For example, the client device 110 may view files made available by the node 115b, and print files on a printer associated with the node 115a. The client device 110 may be implemented using the computing device 700. While illustrated separately in FIG. 1, in some implementations, the client device 110 may itself be a node 115 of the network 120.

As described above, because of the distributed nature of the network 120, the client device 110, and some or all of the nodes 115, may not be aware of all of the nodes 115 that are associated with the network 120. However, a user of the client device 110 may want to know all nodes 115 that are part of the network 120 (i.e., network discovery), or those nodes 115 that are connected to it via a short path, e.g., directly connected to neighbors of the client device 110 (i.e., local flooding). Accordingly, some or all of the nodes 115 may include a discovery engine 130 and a nodes list 125. For purposes of illustration, the discovery engine 130 and the nodes list 125 is only shown as part of the node 115a.

The nodes list 125 associated with a node 115 may be list of all of the node identifiers of the nodes 115 of the network 120 that the node 115 is aware of. Thus, if the node 115a knows that the node 115b, and the node 115c exist, but not that the nodes 115d-g exist, then the nodes list 125 may include identifiers of the nodes 115b and 115c, but may not include identifiers of the nodes 115d-g.

The discovery engine 130 may maintain the nodes list 125 for each node 115. Depending on the implementation, the discovery engine 130 may increase the nodes list 125 of a node 115 using a gossip algorithm. In the gossip algorithm, the discovery engine 130 may randomly select a node identifier from the nodes list 125. The discovery engine 130 may generate a message 118 that includes the nodes list 125 associated with the node 115, and may send the message 118 to the node 115 identified by the selected node identifier. The selected node 115 that receives the message 118 may update its own nodes list 125 based on the nodes list 125 of the message 118, and may respond with a new message 118 that includes its own nodes list 125.

For example, the node 115a may have a nodes list 125 that includes identifiers of the nodes 115b, 115c, and 115d. The node 115b may have a nodes list 125 that includes identifiers of the nodes 115a, 115d, and 115e. After exchanging messages 118, both the nodes 115a and 115b may have a nodes list 125 that includes identifiers of the nodes 115a, 115b, 115c, 115d, and 115e.

When the client device 110 wants to learn the nodes 115 that are available in the network 120, the client device 110 may send a request 140 to the discovery engine 130 executing on any of the nodes 115 that the client device 110 is aware of. The discovery engine 130 may provide the nodes list 125 in response to the request. The client device 110 may use the received nodes list 125 to determine what nodes 115 are available, as well as what nodes 115 are directly connected to the client device 110.

To improve the efficiency of the gossip algorithm described above, the discovery engines 130 of each of the nodes 115 may organize the nodes 115 into one or more clusters. A cluster may be a grouping of one or more nodes 115, with one node 115 in the cluster designated as a leader, and any other nodes 115 in the cluster designated as followers. Depending on the implementation, each follower node 115 in a cluster may share its nodes list 125 with the leader node 115. The leader node 115 may in turn combine the received nodes list 125, and share the combined nodes lists 125 with the follower nodes 115. Thus, every node 115 in a cluster may have the same nodes list 125. By using clusters, in an implementation, the discovery engine 130 may determine all nodes 115 in a network 120 in 000g (log(n)) times where n is the number of nodes 115 in the network 120.

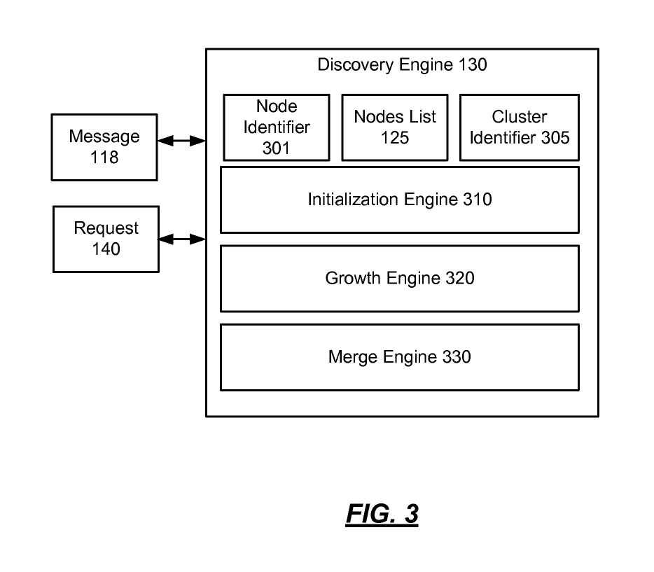

The leader node 115 may instruct the follower nodes 115 to send one or more messages 118 to one or more nodes 115 as described above. The messages 118 may include the nodes list 125 of the node or cluster, and may also invite the recipient nodes (or their associated cluster) to join the cluster that the node that is sending the message is part of. In addition, the leader node may instruct the follower nodes to dissolve (i.e., leave the cluster), to form one or more smaller clusters, or to merge with another cluster. The operation of the discovery engine 130 with respect to clusters is described further with respect to FIG. 3.

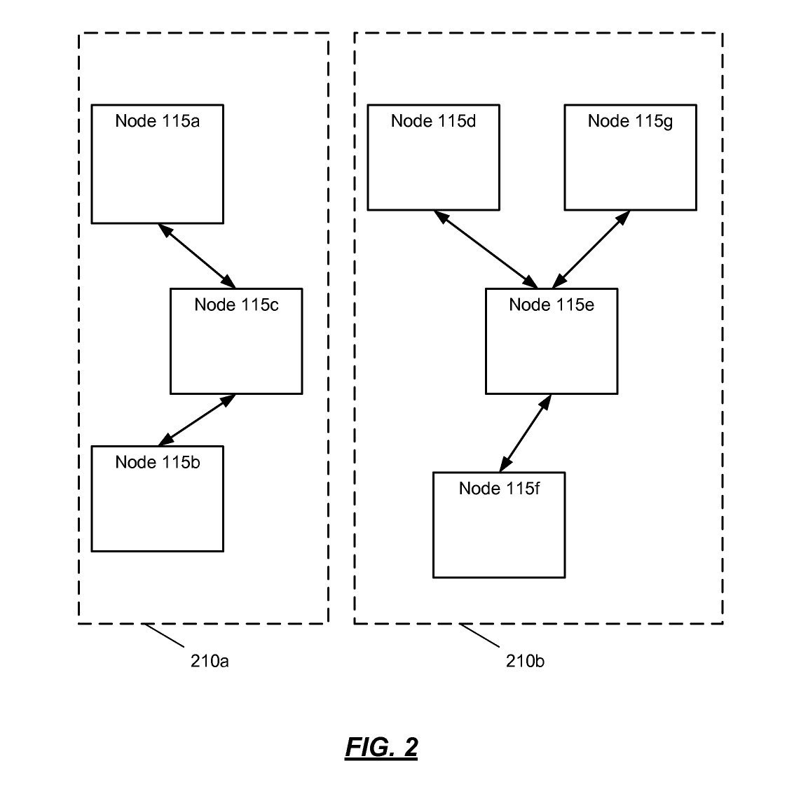

FIG. 2 is an illustration of two example clusters 210a and 210b. The cluster 210a includes the nodes 115a, 115b, and 115c. The cluster 210b includes the nodes 115d, 115g, 115e, and 115f. In the cluster 210a, the node 115c is the leader node, and the nodes 115a and 115b are the follower nodes. In the cluster 210b, the node 115e is the leader node, and the nodes 115d, 115g, and 115f are the follower nodes.

FIG. 3 is an illustration of an example discovery engine 130. The discovery engine 130 may comprise one or more components including a node identifier 301, a nodes list 125, a cluster identifier 305, an initialization engine 310, growth engine 320, and a merge engine 330. More or fewer components may be supported. Some or all of the components of the discovery engine 130 may be implemented by one or more computing devices such as the computing device 700 of FIG. 7.

The node identifier 301 may identify the particular node 115 that the discovery engine 130 is part of. The node identifier 301 may be an IP address, or other network address. The nodes list 125 may be a list of node identifiers 301 that the discovery engine 130 is aware of.

The cluster identifier 305 may identify the cluster that that the node 115 associated with the discovery engine 130 is a part of. In some implementations, the cluster identifier 305 may be the same as the node identifier 301 of the leader node of the cluster. Thus, for the cluster 210a, the cluster identifier 305 of each of the nodes 115a, 115b, and 115 is an identifier of the node 115c, because the node 115c is the leader node of the cluster 210a. A cluster identifier 305 that is the same as the node identifier 301 may indicate that the particular node is the leader of a cluster.

The cluster identifier 305 may be set to a default value to indicate that the node is not part of a cluster. The default value may be null, or a value that is outside of a range of valid node identifiers 301, for example. Other default values may be used.

The initialization engine 310 may implement an initialization phase for the discovery engine 130. During the initialization phase, the nodes of the network 120 may be organized into one or more clusters. The initialization phase may be an optional phase, and while not strictly necessary, may allow subsequent phases to operate more quickly and/or efficiently.

In some implementations, the initialization engine 310 of a node may begin the initialization phase by setting the cluster identifier 305 to the default value. The default value may indicate that the node is not yet part of a cluster.

The initialization engine 310 may then randomly determine whether to declare itself a leader node. For example, the initialization engine 310 may make the determination with a probability that is based on an estimated or likely number of nodes in the network 120. For example, the probability of the node becoming a cluster leader may be 1/C log(n) where C is a constant selected by a user or administrator and n is the number of nodes in the network 120.

If the node is part of a cluster (or declared itself a cluster), the initialization engine 310 may instruct all of the follower nodes in the cluster to randomly select a node from their nodes list 125. Where a node is the only node in the cluster, it may randomly select a node from its own nodes list 125. The follower nodes may each send a message 118 to their selected node. The message 118 may include the cluster identifier 301, and in some implementations, the nodes list 125.

If the node is not part of a cluster (i.e., unclustered), the initialization engine 310 may instruct the node to wait for one or more messages 118 to be received from one of the other nodes. If the node receives a message, the initialization engine 310 may join the cluster identified by the cluster identifier 305 associated with the received message by setting the cluster identifier 305 of the discovery engine 130 to the received cluster identifier 305. If no message is received, the node may remain unclustered.

The initialization engine 310 may repeat the above operations for some number of iterations. For example, in some implementations, the initialization engine 310 may repeat the operations of the initialization phase for Θ(log(log(n)) iterations.

The growth engine 320 may implement a growth phase for the discovery engine 130. During the growth phase, the size clusters of the network 120 may be increased. Depending on the implementation, after each iteration of the growth phrase, the number of nodes in some or all of the clusters may be increased by some power and/or squared.

Initially, a variable s may be set by the growth engine 320 based on the number of nodes in the network n or on the current cluster size. For example, the value of s may be initially set to C(log(n)) where C is a sufficiently large constant selected by a user or administrator.

The growth engine 320 may then determine whether to dissolve the cluster associated with the node. In some implementations, the growth engine 320 may determine whether to dissolve the cluster by first determining the number of follower nodes associated with the cluster. For example, the leader node may determine the number of follower nodes by sending a message 118 to each follower node, and counting the number of responses that are received. If the total number of follower nodes is less than s, then the growth engine 320 may dissolve the cluster. The growth engine 320 may dissolve a cluster by the leader node sending a message to each of the follower nodes with an instruction to set their cluster identifier 305 to the default value. After setting the cluster identifiers 305 to the default value, the nodes will no longer be associated with any cluster.

If the cluster is not dissolved, the growth engine 320 may enter a loop that may repeat until the value of S exceeds a threshold. Within the loop, the growth engine 320 determines if the cluster associated with the growth engine 320 may be resized. In some implementations, the cluster may be resized if the number of followers in the cluster exceeds a threshold. The threshold may be 2 s. Other thresholds may be used. The number of follower nodes in a cluster may be determined by the leader node as described above. If the cluster exceeds the threshold, then the growth engine 320 may divide the cluster into two or more approximately equally sized clusters, for example, of size about 2 s.

Depending on the implementation, the growth engine 320 may divide the cluster by the leader node selecting two or more node identifiers 301 from the follower nodes. The selected node identifiers may then be provided to the follower nodes in a message 118. The follower nodes may each select the largest received node identifier 301 that is not larger than their own node identifier 301. Each node may set its cluster identifier 305 to be equal to the selected node identifier 301.

The growth engine 320 may determine whether to activate or deactivate the cluster associated with the node that the discovery engine 130 is associated with. Depending on the implementation, the growth engine 320 may determine to randomly activate or deactivate the cluster based on the value of S. For example, the growth engine 320 may activate or deactivate the cluster with probability 1/s. Other methods may be used. In general, the nodes associated with an activated cluster may send messages to selected nodes, while nodes associated with a deactivated cluster may wait to receive messages from other nodes.

For active clusters, the growth engine 320 of the leader node, in a first iteration, may instruct the follower nodes in the cluster to randomly select a node from their nodes list 125, and to send a message to the selected node with a request to join the cluster. The message may include the cluster identifier 305 and the nodes list 125. The follower nodes may receive the messages in response, and the messages may include a nodes list 125.

In addition, in a second iteration, the growth engine 320 may instruct the follower nodes in the cluster to randomly select a node from their nodes list 125 that is also not part of a cluster associated with the node that was sent the message in the first iteration, and to send a message to the selected node with a request to join the cluster associated with the growth engine 320. The nodes that are part of the cluster may be determined from the nodes list 125 that was received in the message.

For inactive clusters, the growth engine 320 of the leader node, in a first iteration, may instruct the follower nodes in the cluster to merge with a cluster identified by a cluster identifier 305 that was received in a message by one of the follower nodes. The cluster identifier 305 may be selected by the growth engine 320 from one of the messages received by a follower node of the inactive cluster. Depending on the implementation, a follower node may merge with, or join, a cluster by changing its cluster identifier to the cluster identifier associated with the target cluster. Similar to the active clusters described above, the inactive clusters may receive messages, and merge with selected clusters for two iterations.

After the two iterations, the growth engine 320 may set the value of s to s^{1.5}, or some smaller polynomial in s, and may return to the beginning of the loop described in paragraph [0039]. The growth engine 320 may continue to grow the clusters as described above until the value of S is greater than a threshold value. The threshold value may be based on the estimated number of nodes in the network 120. For example, the threshold may be

$$\frac{\sqrt{n}}{log n} .$$

Other threshold values may be used.

The merge engine 330 may implement a merge phase for the discovery engine 130. During the merge phase, the clusters grown during the growth phase may be merged to create a single cluster. Depending on the implementation, the merge engine 330 may start the merge phase by instructing all of the follower nodes to send a message to a randomly selected node from their nodes list 125. The merge engine 330 may also further instruct the follower nodes to merge with, or join, a cluster identified in any message received by the follower node. The follower nodes may merge with the cluster having the smallest received cluster identifier 305, for example.

The merge engine 330 may repeat the merge phase for two iterations. After the two iterations have completed, there may remain only one cluster in the network 120.

Depending on the implementation, even after the clusters have been merged, there may remain a few nodes in the network 120 that were never added to a cluster and therefore remain unclustered. To account for such nodes, the merge engine 330 may further merge any unclustered nodes into the cluster. If a node associated with the merge engine 330 is unclustered (i.e., the cluster identifier 305 is the default value), the merge engine 330 may request a cluster identifier 305 from any node 115 selected from the nodes list 125. The merge engine 330 may request the cluster identifier 305 using a message 118, for example. The merge engine 330 may continue to request cluster identifiers until a cluster identifier is received (and the node joins the associated cluster), or after some number of messages have been sent.

After the various phases described above have been performed, each node 115 in the one remaining cluster may have a nodes list that identifies all of the nodes that are available on the network. Accordingly, the discovery engine 130 may provide the nodes list 125 in response to a request 140 received from a client device 110. Depending on the implementation, the discovery engine 130 may execute one or more of the initialization phase, growth phase, and merge phase each time a request 140 is received to ensure that the requesting client device 110 receives the most up to date listing of available nodes. Alternatively, the discovery engine 130 may execute one or more of the initialization phase, growth phase, and merge phase on a regularly scheduled basis, such as every hour, every 24 hours, etc., for example.

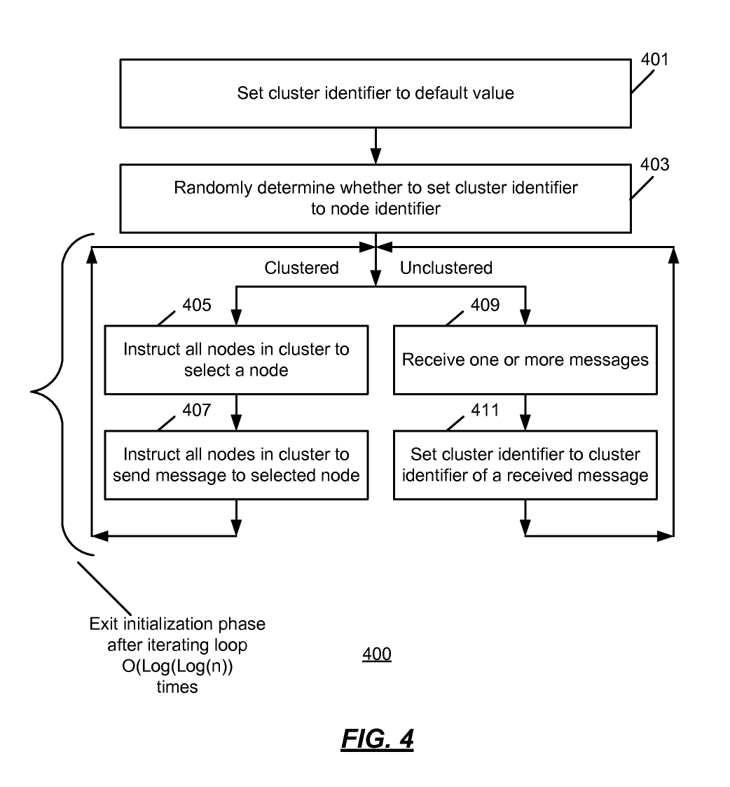

FIG. 4 is an illustration of an operational flow of a method 400 for performing an initialization phase. The method 400 may be implemented by a discovery engine 130 of each of a plurality of nodes 115 associated with a network 120.

At 401, a cluster identifier is set to a default value. The cluster identifier 305 of the node may be set by the initialization engine 310 of the discovery engine 130. The default value may be null, or some other default value, for example.

At 403, a random determination is made as to whether to set the cluster identifier associated with the node to be the same as the node identifier. Setting the cluster identifier to the node identifier may establish the node as the cluster leader. During the initialization phase, setting the cluster identifier to the node identifier may make the node its own singleton cluster. The determination may be made by the initialization engine 310 of the discovery engine 130, and may be made based on the number of nodes in the network 120. If the cluster identifier 305 is set to the node identifier 301, then the node is a clustered node, and the method 400 may continue at 405. Otherwise, the node is unclustered, and the method 400 may continue at 409.

At 405, all nodes associated with the cluster are instructed to select a node. The instructions may be provided by the initialization engine 310 of the discovery engine 130 associated with the leader node of the cluster. Each node may have a nodes list 125 that identifies all nodes that the node is aware of in the network 120, and the selected node may be randomly selected from the nodes list 125. As may be appreciated, initially, the leader node may be the only node in the cluster and may therefore select the node from its own nodes list.

At 407, the nodes associated with the cluster are instructed to send a message to the selected node. The instructions may be provided by the initialization engine 310 of the discovery engine 130 associated with the leader node of the cluster. The message may include the cluster identifier of the cluster. Similarly as for 405, if the leader node is the only node in the cluster, the leader node may send the message. After sending the message, the method 400 may return to 405 to select another node to contact.

At 409, one or more messages may be received. The messages may be received by the initialization engine 310 of the discovery engine 130. Each received message may include a cluster identifier 305.

At 411, the cluster identifier is set to a cluster identifier associated with a received message. The cluster identifier 305 may be set by the initialization engine 310 of the discovery engine 130 of the node. Where multiple messages are received, the initialization engine 310 may set the cluster identifier to the largest received cluster identifier from a message. Alternatively, the cluster identifier 305 may be randomly selected. After setting the cluster identifier, the method 400 may continue at 405 because the associated node is now clustered. Where no messages are received by a node, the node may remain unclustered and the method 400 may return to 409.

Depending on the implementation, the loop represented by operations 405, 407, 409, and 411 may be repeated a predetermined number of times. For example, the operations may be repeated Θ(log(log(n)) times where n is the number of nodes in the network 120.

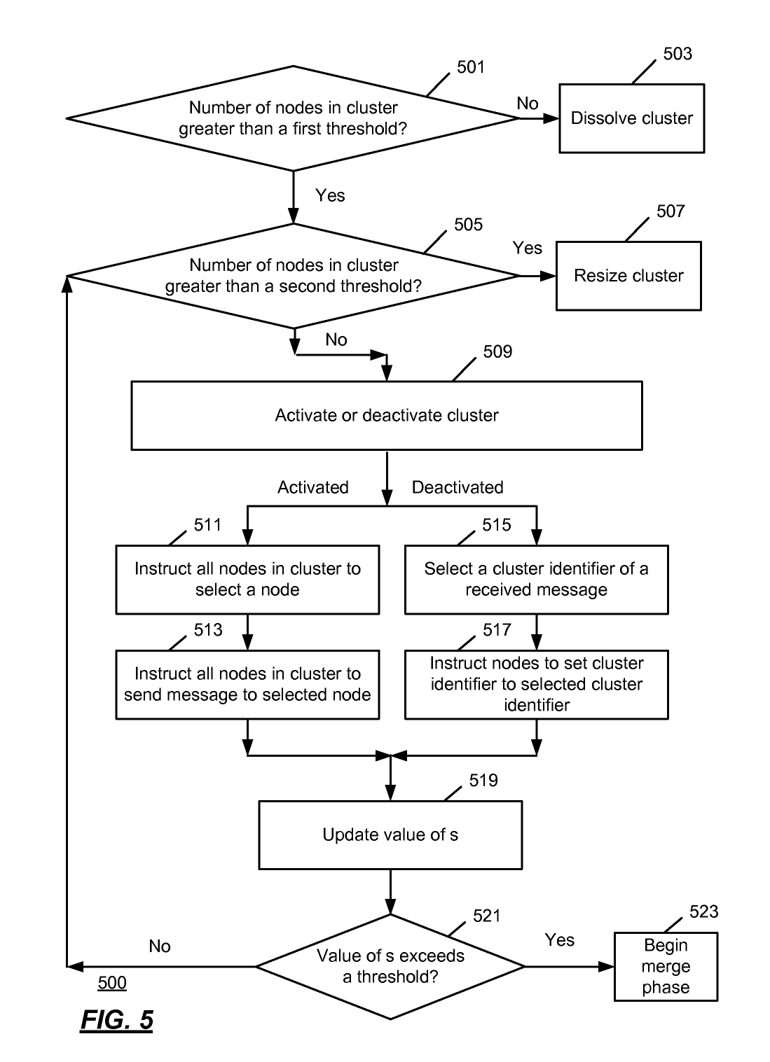

FIG. 5 is an illustration of an operational flow of a method 500 for performing a growth phase. The method 500 may be implemented by a discovery engine 130 of each leader node of a plurality of nodes 115 associated with a network 120.

At 501, a determination is made as to whether a number of nodes in a cluster is greater than a first threshold. The determination may be made by the growth engine 320 of the discovery engine 130 associated with the leader node of the cluster. The first threshold may be a minimum cluster size and may be based on a value s. The value s may be selected by a user or administrator and/or may be based on the total number of nodes 115 in the network 120. If the number of nodes 115 in the cluster exceeds the first threshold, then the method 500 may continue at 505. Otherwise, the method 500 may continue at 503.

At 503, the cluster is dissolved. The cluster may be dissolved by the growth engine 320 of the discovery engine 130 by the leader node (and all of the follower nodes) setting its cluster identifier 305 to the default value. Any node of the dissolved cluster may then wait to receive a message 118 from a node associated with an active cluster.

At 505, a determination is made as to whether a number of nodes in a cluster is greater than a second threshold. The determination may be made by the growth engine 320 of the discovery engine 130 associated with the leader node of the cluster. The second threshold may be a maximum cluster size and may similarly be based on the value s. For example, the second threshold may be 2 s. If the number of nodes in the cluster exceeds the second threshold, then the method 500 may continue at 507. Otherwise, the method 500 may continue at 509.

At 507, the cluster is resized. The cluster may be resized by the growth engine 320 of the discovery engine 130 by the leader node dividing the follower nodes of the cluster into two or more new clusters. Depending on the implementation, the growth engine 320 of the leader node may select a follower node to be a leader node of a new cluster, and may instruct the selected node and some subset of the nodes in the cluster, to set its cluster identifier 305 to the selected node.

At 509, it is determined whether to activate or deactivate the cluster. The determination may be made by the growth engine 320 of the discovery engine 130 associated with the leader node of the cluster. Depending on the implementation, the determination may be randomly made by the growth engine 320 based on the value s, such as activating it with probability 1/s, for example. If the cluster is activated, the method 500 may actively seek other nodes and clusters to merge with at 511. If the cluster is deactivated, then the method 500 may passively wait to be invited to join another cluster at 515.

At 511, all nodes associated with the cluster are instructed to select a node. The instructions may be provided by the growth engine 320 of the discovery engine 130 associated with the leader node of the cluster. Each node may select a node from its nodes list 125.

At 513, the nodes associated with the cluster are instructed to send a message to the selected node. The instructions may be provided by the growth engine 320 of the discovery engine 130 associated with the leader node of the cluster. After sending the message 118, the method 500 may continue at 519.

Depending on the implementation, the method 500 may repeat the operations 511 and 513 for two or more iterations. After the first iteration, messages may be received in response to the sent messages. Each received message may identify a cluster associated with the node that sent the message. For subsequent iterations, only nodes that are not part of a cluster that was identified in a received message may be selected.

At 515, a cluster identifier of a received message is selected. The cluster identifier 305 may be selected by the growth engine 320 of the discovery engine 130 associated with the leader node of the cluster. The cluster identifier 305 may be selected from all messages received by the follower nodes of the cluster. Depending on the implementation, the leader node may select the node with the smallest cluster identifier 305.

At 517, each node is instructed to set its cluster identifier to the selected cluster identifier. The nodes may be instructed by the growth engine 320 of the discovery engine 130 of the leader node of the cluster. The method 500 may then continue at 519.

At 519, the value of S is updated. The value S may be updated by the growth engine 320 of the discovery engine 310 by setting it to s^{1.5} and thus essentially squaring the previous value of s. As described above, the value of S may be used in determining the second threshold at 505, and whether or not to activate or deactivate a cluster.

At 521, it is determined whether the value of S exceeds a threshold. The determination may be made by the growth engine 320 of the discovery engine 310. The threshold may be

$$\frac{\sqrt{n}}{log n} .$$

Other thresholds may be used. If the value of s does not exceed the threshold, the method 500 may return to 505. Otherwise, the method 500 may begin the merge phase at 523 where one or more of the clusters may be combined into a single cluster.

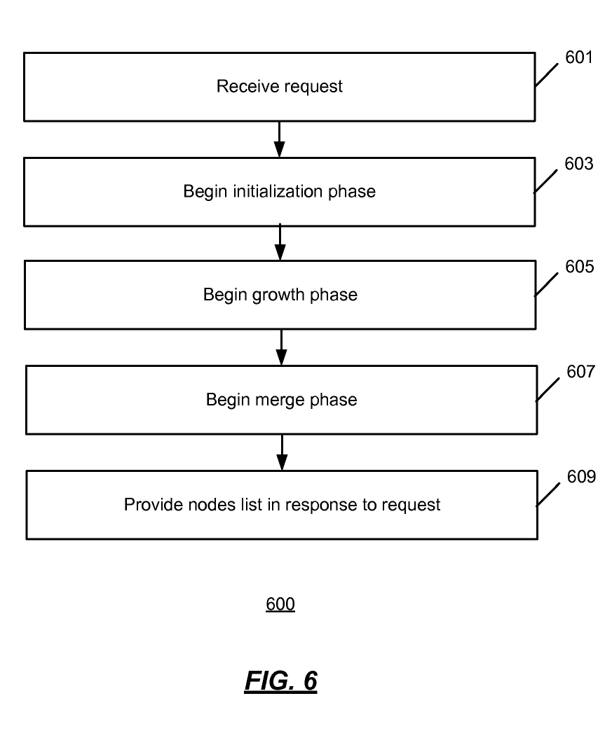

FIG. 6 is an illustration of an operational flow of a method 600 for determining node identifiers in response to a request. The method 600 may be implemented by a discovery engine 130 associated with a network 120.

At 601, a request is received. The request may be received by the discovery engine 130 of a node of a plurality of nodes 115 associated with a network 120. The request may be a request 140 and may be a request to identify the nodes that are on the network 120. In response to the request, the discovery engine 130 may begin to determine the nodes that are available on the network 120.

At 603, the initialization phase may begin. The initialization phase may be implemented by the initialization engine 310 of the discovery engine 130. During the initialization phase, some or all of the nodes 115 may be assigned to a cluster of a plurality of clusters. Depending on the implementation, a node may be assigned to a cluster by setting its cluster identifier 305 to the node identifier 301 of the leader node of the cluster.

At 605, the growth phase may begin. The growth phase may be implemented by the growth engine 320 of the discovery engine 130. During the growth phase, the growth engine 320 may randomly activate or deactivate each cluster of the plurality of clusters. For each activated cluster, the growth engine 320 of the leader node of the activated cluster may instruct all of the follower nodes to send a message to a randomly selected node that is not part of the cluster. The message may be a request to join the cluster and may include the cluster identifier 305 of the cluster.

For each deactivated cluster, the growth engine 320 of the leader node of the deactivated cluster may instruct all of the follower nodes to join a cluster identified by a cluster identifier 305 of a received message. Each follower node may join the cluster by setting their cluster identifier to the cluster identifier of the received message. Where multiple messages are received, the growth engine 320 may randomly select the cluster identifier 305, or may select the highest or lowest cluster identifier.

At 607, the merge phase may begin. The merge phase may be implemented by the merge engine 330 of the discovery engine 130. During the merge phase, all of the clusters may merge into a single cluster. In addition, any nodes that have not yet joined a cluster, may be incorporated into the cluster.

At 609, a nodes list is provided in response to the request. The nodes list 125 may be provided by the discovery engine 130 of the leader node of the cluster. Depending on the implementation, the discovery engine 130 may provide the nodes list 125 by the leader node requesting the nodes list 125 of each of the follower nodes in the cluster. The leader node may update the nodes list 125 based on the nodes identified in the nodes lists provided by each of the follower nodes.

FIG. 7 shows an exemplary computing environment in which example embodiments and aspects may be implemented. The computing device environment is only one example of a suitable computing environment and is not intended to suggest any limitation as to the scope of use or functionality.

Numerous other general purpose or special purpose computing devices environments or configurations may be used. Examples of well-known computing devices, environments, and/or configurations that may be suitable for use include, but are not limited to, personal computers, server computers, handheld or laptop devices, multiprocessor systems, microprocessor-based systems, network personal computers (PCs), minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 7, an exemplary system for implementing aspects described herein includes a computing device, such as computing device 700. In its most basic configuration, computing device 700 typically includes at least one processing unit 702 and memory 704. Depending on the exact configuration and type of computing device, memory 704 may be volatile (such as random access memory (RAM)), non-volatile (such as read-only memory (ROM), flash memory, etc.), or some combination of the two. This most basic configuration is illustrated in FIG. 7 by dashed line 706.

Computing device 700 may have additional features/functionality. For example, computing device 700 may include additional storage (removable and/or non-removable) including, but not limited to, magnetic or optical disks or tape. Such additional storage is illustrated in FIG. 7 by removable storage 708 and non-removable storage 710.

Computing device 700 typically includes a variety of computer readable media. Computer readable media can be any available media that can be accessed by the device 700 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 704, removable storage 708, and non-removable storage 710 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 500. Any such computer storage media may be part of computing device 700.

Computing device 700 may contain communication connection(s) 712 that allow the device to communicate with other devices. Computing device 700 may also have input device(s) 714 such as a keyboard, mouse, pen, voice input device, touch input device, etc. Output device(s) 716 such as a display, speakers, printer, etc. may also be included. All these devices are well known in the art and need not be discussed at length here.

In an implementation, it is determined by a computing device that a number of nodes in a first cluster of a plurality of clusters is greater than a first threshold. Each cluster comprises one or more nodes, each node is assigned to one cluster, each node comprises a node identifier that identifies the node, each node comprises a cluster identifier that identifies the cluster that the node is assigned to, and each node comprises a list of the nodes that the node is aware of. In response to determining that the number of nodes in the first cluster is greater than the first threshold: (a) the first cluster is activated or deactivated by the computing device, and while the first cluster is activated, (b): each node in the first cluster is instructed to select a first node from the list of nodes that the node is aware of by the computing device; and each node in the first cluster is instructed to send a message to the selected first node by the computing device. A request to identify the nodes of the plurality of nodes is received at the computing device. In response to the request, the list of nodes associated with a node of the first cluster is provided by the computing device.

Implementations may include some or all of the following features. That the number of nodes in the first cluster is less than the first threshold may be determined, and in response to determining that the number of nodes in the first cluster is less than the first threshold, the first cluster may be dissolved. Activating or deactivating the first cluster may include randomly activating or deactivating the first cluster. Step (b) may further include: instructing each node in the first cluster to select a second node from the list of nodes that the node is aware of, wherein the second node is associated with a different cluster than the first node; and instructing each node in the first cluster to send a message to the selected second node. The steps may further include (c) while the first cluster is deactivated: receiving cluster identifiers from one or more of the nodes in the first cluster; selecting a cluster identifier from the received cluster identifiers; and instructing each node in the first cluster to join the cluster identified by the selected cluster identifier. Steps (a), (b), and (c) may be repeated. That a number of nodes associated with the first cluster exceeds a second threshold may be determined; and in response to the determination, the number of nodes in the first cluster may be reduced. Each node may be associated with a network resource. One or more clusters of the plurality of clusters may be merged with the first cluster.

In an implementation, (a) a first cluster is activated or deactivated by a computing device. Each cluster comprises one or more nodes, each node is assigned to one cluster, each node comprises a node identifier that identifies the node, each node comprises a cluster identifier that identifies the cluster that the node is assigned to, and each node comprises a list of the nodes that the node is aware of. While the first cluster is activated (b): each node in the first cluster is instructed to select a first node from the list of nodes that the node is aware of by the computing device; and each node in the first cluster is instructed to send a message to the selected first node by the computing device. The message includes the cluster identifier associated with the first cluster. While the first cluster is deactivated (c): cluster identifiers are received from one or more of the nodes in the first cluster by the computing device; a cluster identifier is selected from the received cluster identifiers by the computing device; and each node in the first cluster is instructed to join the cluster identified by the selected cluster identifier by the computing device.

Implementations may include some or all of the following features. Steps (a), (b), and (c) may be repeated. Step (b) may further include instructing each node in the first cluster to select a second node from the list of nodes that the node is aware of, wherein the second node is associated with a different cluster than the first node; and instructing each node in the first cluster to send a message to the selected second node. One or more clusters of the plurality of clusters may be merged with the first cluster. The nodes may include network resources. A request to identify the nodes of the plurality of nodes may be received; and in response to the request, the list of nodes associated with a node of the first cluster may be provided.

In an implementation, a system may include at least one computing device, a plurality of nodes, and a discovery engine. Each node may include a node identifier that identifies the node, and each node may include a list of the nodes of the plurality of nodes that the node is aware of. The discovery engine may be adapted to: in an initialization phase, assign one or more nodes of the plurality of nodes to a cluster of a plurality of clusters, wherein each cluster includes at least one node, and each node includes a cluster identifier that identifies the cluster that the node is assigned to; and in a growth phase, grow one or more of the clusters by: randomly activating or deactivating each cluster of the plurality of clusters; for each activated cluster, instructing each node of the activated cluster to send a message to a randomly selected node from the list of nodes associated with the node of the activated cluster, wherein the message comprises the cluster identifier associated with the node of the activated cluster; and for each deactivated cluster, instructing each node of the deactivated cluster to join a cluster identified by a cluster identifier from a received message.

Implementations may include some or all of the following features. The discovery engine may be further adapted to: receive a request to identify the nodes of the plurality of nodes; and in response to the request, provide the list of nodes associated with a node of a cluster. The discovery engine adapted to assign one or more nodes of the plurality of nodes to a cluster of a plurality of clusters may include the discovery engine adapted to: for each node of the plurality of nodes: set the cluster identifier of the node to a default value; randomly determine whether or not to set the cluster identifier to be equal to the node identifier associated with the node; and set the cluster identifier to be equal to the node identifier associated with the node based on the determination. The discovery engine may be further adapted to: in a merge phase, merge one or more of the plurality of clusters. The nodes may include network resources.

It should be understood that the various techniques described herein may be implemented in connection with hardware components or software components or, where appropriate, with a combination of both. Illustrative types of hardware components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. The methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices might include personal computers, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method comprising:
determining that a number of nodes in a first cluster of a plurality of clusters is greater than a first threshold by a computing device, wherein each cluster comprises one or more nodes of a plurality of nodes, each node is assigned to one cluster, each node comprises a node identifier that identifies the node, each node comprises a cluster identifier that identifies the cluster that the node is assigned to, and each node comprises a list of the nodes of the plurality of nodes that the node is aware of;
in response to determining that the number of nodes in the first cluster is greater than the first threshold:
(a) activating or deactivating the first cluster by the computing device; and
(b) while the first cluster is activated:
instructing each node in the first cluster to select a first node from the list of nodes that the node is aware of by the computing device, wherein the first node is not in the first cluster; and
instructing each node in the first cluster to send a message to the selected first node by the computing device, wherein the message includes the cluster identifier of the first cluster;
receiving a request to identify the nodes of the plurality of nodes at the computing device; and
in response to the request, providing the list of nodes associated with a node of the first cluster by the computing device.

2. The method of claim 1, further comprising:
determining that the number of nodes in the first cluster is less than the first threshold; and
in response to determining that the number of nodes in the first cluster is less than the first threshold, dissolving the first cluster.

3. The method of claim 1, wherein activating or deactivating the first cluster comprises randomly activating or deactivating the first cluster.

4. The method of claim 1, wherein (b) further comprises:
instructing each node in the first cluster to select a second node from the list of nodes that the node is aware of, wherein the second node is associated with a different cluster than the first node; and
instructing each node in the first cluster to send a message to the selected second node.

5. The method of claim 1, further comprising:
(c) while the first cluster is deactivated:
receiving cluster identifiers from one or more of the nodes in the first cluster;
selecting a cluster identifier from the received cluster identifiers; and
instructing each node in the first cluster to join the cluster identified by the selected cluster identifier.

6. The method of claim 5, further comprising repeating (a), (b), and (c).

7. The method of claim 1, further comprising:
determining that a number of nodes associated with the first cluster exceeds a second threshold; and
in response to the determination, reducing the number of nodes in the first cluster.

8. The method of claim 1, wherein each node is associated with a network resource.

9. The method of claim 1, further comprising merging one or more clusters of the plurality of clusters with the first cluster.

10. A method comprising:
(a) activating or deactivating a first cluster of a plurality of clusters by a computing device, wherein each cluster comprises one or more nodes of a plurality of nodes, each node is assigned to one cluster, each node comprises a node identifier that identifies the node, each node comprises a cluster identifier that identifies the cluster that the node is assigned to, and each node comprises a list of the nodes of the plurality of nodes that the node is aware of;
(b) while the first cluster is activated:
instructing each node in the first cluster to select a first node from the list of nodes that the node is aware of by the computing device; and
instructing each node in the first cluster to send a message to the selected first node by the computing device, wherein the message includes the cluster identifier associated with the first cluster;
(c) while the first cluster is deactivated:
receiving cluster identifiers from one or more of the nodes in the first cluster by the computing device;
selecting a cluster identifier from the received cluster identifiers by the computing device; and
instructing each node in the first cluster to join the cluster identified by the selected cluster identifier by the computing device.

11. The method of claim 10, further comprising repeating (a), (b), and (c).

12. The method of claim 10, wherein (b) further comprises:
instructing each node in the first cluster to select a second node from the list of nodes that the node is aware of, wherein the second node is associated with a different cluster than the first node; and
instructing each node in the first cluster to send a message to the selected second node.

13. The method of claim 10, further comprising merging one or more clusters of the plurality of clusters with the first cluster.

14. The method of claim 10, wherein the nodes comprise network resources.

15. The method of claim 10, further comprising:
receiving a request to identify the nodes of the plurality of nodes; and
in response to the request, providing the list of nodes associated with a node of the first cluster.

16. A system comprising:
at least one computing device;
a plurality of nodes, wherein each node comprises a node identifier that identifies the node, and each node comprises a list of the nodes of the plurality of nodes that the node is aware of; and
a discovery engine adapted to:
in an initialization phase, assign one or more nodes of the plurality of nodes to a cluster of a plurality of clusters, wherein each cluster comprises at least one node, and each node comprises a cluster identifier that identifies the cluster that the node is assigned to; and
in a growth phase, grow one or more of the clusters by:
randomly activating or deactivating each cluster of the plurality of clusters;
for each activated cluster, instructing each node of the activated cluster to send a message to a randomly selected node from the list of nodes associated with the node of the activated cluster, wherein the message comprises the cluster identifier associated with the node of the activated cluster; and
for each deactivated cluster, instructing each node of the deactivated cluster to join a cluster identified by a cluster identifier from a received message.

17. The system of claim 16, wherein the discovery engine is further adapted to:
receive a request to identify the nodes of the plurality of nodes; and
in response to the request, provide the list of nodes associated with a node of a cluster.

18. The system of claim 16, wherein the discovery engine adapted to assign one or more nodes of the plurality of nodes to a cluster of a plurality of clusters comprises the discovery engine adapted to:
for each node of the plurality of nodes:
set the cluster identifier of the node to a default value;
randomly determine whether or not to set the cluster identifier to be equal to the node identifier associated with the node; and
set the cluster identifier to be equal to the node identifier associated with the node based on the determination.

19. The system of claim 16, wherein the discovery engine is further adapted to:
in a merge phase, merge one or more of the plurality of clusters.

20. The system of claim 16, wherein the nodes comprise network resources.
